(19) United States
(12) Patent Application Publication
(10) Pub. No.: US 2017/0060979 A1
(43) Pub. Date: Mar. 2, 2017

(54) Action Group Loading and Operation

(71) Applicants: David Webster, Morrisville, NC (US); John Anderson, Morrisville, NC (US); Manjiri Kshirsagar, Morrisville, NC (US); Ryan Corbin, Morrisville, NC (US)

(72) Inventors: David Webster, Morrisville, NC (US); John Anderson, Morrisville, NC (US); Manjiri Kshirsagar, Morrisville, NC (US); Ryan Corbin, Morrisville, NC (US)

(21) Appl. No.: 14/809,507

(22) Filed: Aug. 28, 2015

(51) Int. Cl. G06F 17/30; H04L 12/28; H04L 29/08

(52) U.S. Cl. CPC G06F 17/30598; H04L 67/12; H04L 12/2803

(57) ABSTRACT

This document presents a system and method for defining and controlling lights, audio systems, and any other home automation device as part of an action group. Action groups may be defined to serve as a single point of control for all devices assigned to a control button such that selection of the control button toggles on or off all lights and devices assigned to the action group. Action groups may be defined for locations that are in communication with a master control unit and do not have to be electrically connected to the master control unit. Multiple action groups may be defined and activated through a single master control unit.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

This innovation relates generally to the home automation market. In a home automation system, many different electrical and mechanical elements can be controlled via electrical connection into one or more electrical circuits. Many times, a user may wish to control these elements synchronously via a single action such as selecting a switch or pressing a button. An electrical circuit may be configured to activate and deactivate a multitude of devices providing light, audio, temperature control, security control and any other functions that an owner of a property may wish to have under automated control.

Home automation may also consist of input and decision control such that timers and other delay devices may be employed to activate circuit control when an owner is not present. Configuring a home automation system may include the attachment of a decision execution device such as a computer processor connected to the input of the electrical circuit to process actions associated with decisions desired by the home owner.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of a system component configuration consistent with certain embodiments of the present invention.

FIG. 2 is a view of a multi-function control switch consistent with certain embodiments of the present invention.

FIG. 3 is an exemplary screen shot of a set of control areas that may be included in an action group consistent with certain embodiments of the present invention.

FIG. 4 is an exemplary screen shot of an update to a control button consistent with certain embodiments of the present invention.

FIG. 5 is an exemplary screen shot of the creation of an action group configuration consistent with certain embodiments of the present invention.

FIG. 6 is an exemplary screen shot of an action group associated with a control button consistent with certain embodiments of the present invention.

FIG. 7 is a view of an initial state for the system configuration on a display device consistent with certain embodiments of the present invention.

FIG. 8 is a view of an action group activated consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “mobile device” refers to any handheld device such as, but not limited to, a smart phone, tablet, iPad, networked computer, internet computer, watch or any other device a user may carry when travelling from place to place and interact with one or more networks.

In an exemplary embodiment, an action is defined in this embodiment as a single state change of a particular element contained within a home automation system. Actions include, but are not limited to, turning a light on or off, stopping or starting music, changing the volume of a music playback, setting temperature and environmental controls, setting timers, controlling security systems, and other similar actions a user might take in their home to control one or more devices. In this exemplary embodiment, if a user wishes to execute multiple actions, the user may initiate each of the actions individually via their desired control method. Such desired control methods may include tapping the light switch or changing the music via a mobile application or setting a thermostat through a tablet-based control icon. For a large number of actions, these may be prohibitively time intensive, or user action intensive, methods. The concept of action groups permits a user to group an arbitrary set of desired control methods that have previously been expressed as singular actions and permits them to be executed simultaneously.

In an embodiment, the implementation of action groups requires three parts, the elements to be controlled, such as, in a non-limiting example, lights, music, thermostats, security systems, rheostats, and other devices in the home, the central networking hub, and a method of user configuration. In this exemplary embodiment, the elements to be controlled may be electrically connected to one or more wired or wireless connections. The wired connections may be present to provide power and/or control signals, and the wireless connection may operate in conjunction with a wired electrical connection to provide configuration, command, and control signals. Each device connected to the system may have wired, wireless, or both types of electrical and control connectivity. In this exemplary embodiment, configuration and control instructions may be input to the system through a mobile application that may generally be provided for the user as a control entry mechanism. The mobile application may be downloaded to a smartphone, tablet, internet computer, or any other device containing a processor and the two-way communication necessary to connect with the Internet. The application may be downloaded from a commercial internet server, such as, in a non-limiting example, Google Play or the Apple AppStore, and installed as the command and control manager for the system. The elements to be controlled may be connected to the central hub via a wired or wireless connection as demonstrated in an associated example system diagram.

In an exemplary embodiment, for the multiple action group loading application, each action group may be tied to a control button, where a control button is any portion of a physical component of the system that may be configured to transmit an activation signal to the main processor of the system when the portion of the physical component is selected. The selection of the portion of the physical component that forms the control button may be performed through touching the control button, or through an activation signal from a handheld unit such as a smart phone, tablet, intern& computer, or other handheld device. A physical component of the system, such as, in a non-limiting example, a light switch panel, may comprise more than one control button. The light switch panel may have a pre-configured number of different segments that each may be configured to serve as a control button. Other physical components of the system may be configured to serve as control buttons, with each portion of a physical component separately configurable.

In an exemplary implementation, a physical button may be implemented as a portion of a light switch, but a control button may also be implemented as a digital button on a mobile application. Action groups may be configured to be associated with a particular control button. An action group may span a series of devices on a particular circuit, a series of circuits with associated devices, circuits within one or more properties, or any other configuration of devices that may be in wired or wireless communication with a master control unit. When a user wishes to configure an action group, the user may use an input device such as, in a non-limiting example, a smart phone, tablet, iPad, intern& computer or other mobile device on which the configuration application has been downloaded and installed. The user may initiate the configuration application to drag and drop an icon or text description on a display presented to the user by the configuration application. The display may identify each action and permit the association of an action with a particular action group. An action group may be mapped onto an icon representing the desired control button. Configuration actions may be repeated for each identified action to be associated with the action group being defined and associated with one or more control buttons until the user has met the limit of controls that may be associated with a single action group, or the user is satisfied with the actions in the action group being defined. The control button is now configured to initiate the execution of the group of actions that have been associated with the control button.

In an exemplary embodiment, each configuration of a control button defined by a user may be saved in a database configured, maintained, and managed by the master control unit. The physical component, such as a light switch panel, or mobile application element that contains the control button to control the group will also save a reference to that action group in the control button database maintained in the master control unit. When the control button is pressed after configuration, a message is sent from the physical element to the master control unit containing that reference to the database entry which will subsequently send messages to each of the elements contained in the action group to execute the desired actions.

In an embodiment, the primary benefits to the action group concept include simplification of use of a home automation system and the ability to control elements that are not electrically connected to each other and are located remotely from the master control unit. In the first instance, the action groups allow users to more efficiently execute multiple desired actions simultaneously. In the second instance, the ability to control “remote” elements, those that are not electrically connected to each other may include, in a non-limiting example, elements located in one physical location, such as a house or other building, and elements located in a second physical location, such as a detached garage, outbuilding, guard shack, or any other physical location. The control of disparate devices may be combined into a single action group or may be combined in several action groups each of which may have elements in multiple physical locations. Each element must be configured within and addressable by the master control unit to permit a control signal to be sent when a control button is selected. This simplifies ability to send control signals to each physical device so as to create control over action groups having elements in new installations, as well as permitting existing installations to keep their current electrical wiring yet still receive the advantage of control through an action group.

In addition to devices and control actions that are defined in the system, the user may have the ability to add new devices and new control commands to the system to update and enhance the system capabilities in a dynamic fashion. In a non-limiting example of this configuration update capability, a three way switch may be added via user configuration with no change to electrical wiring through the action of defining the three way connection within an action group, assigning that action group to a control button, and causing the three way switch to be active when the control button is selected. The additional dynamically defined devices and control commands may be stored in the system database of the master control unit for future retrieval and use.

The system and method recited comprises one or more processors upon which are installed a management software module on the processor operative to control one or more electrical devices, an input device in communication with the processor available to a user to input electrical device identification information, and a database accessible by the processor operative to receive the input electrical device identification information. The system and method is also operative to define one or more action groups where each action group comprises multiple electrical device identification information, and the management software module simultaneously controls the state of each electrical device in each defined action group at the request of a user.

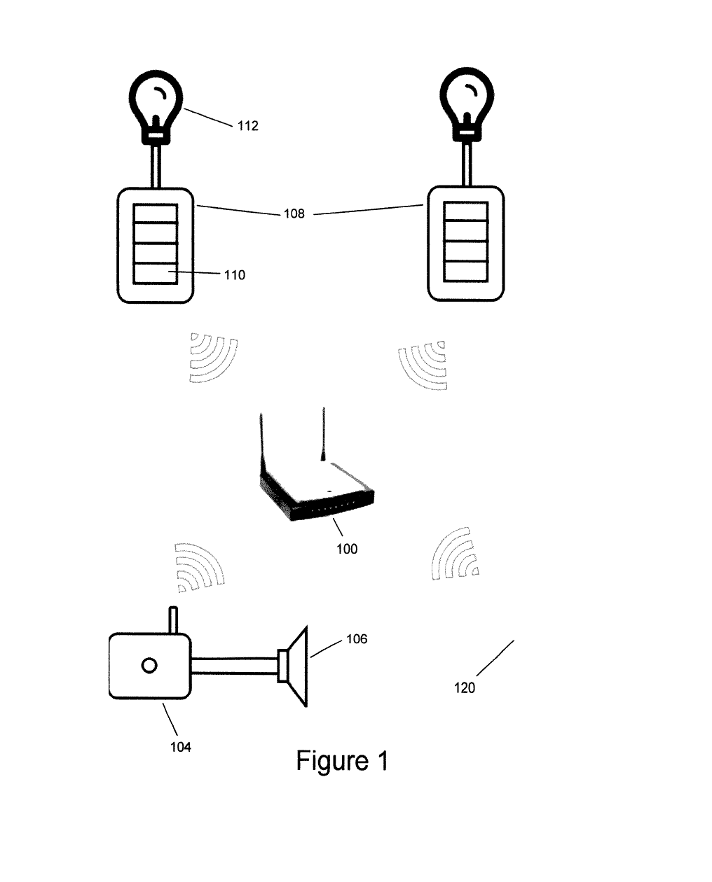

Turning now to FIG. 1, this figure presents a view of a system component configuration consistent with certain embodiments of the present invention. In an exemplary embodiment, the master control unit 100 is a wired and wireless capable device that communicates with each device, circuit, database and component in the system. The master control unit 100 is responsible for configuration, control and management of the communication with and between each device in the system. In a non-limiting example, the master control unit 100 is displayed in a typical basic system configuration.

In this non-limiting example, the master control unit 100 receives communication signals from different devices that control segments of the home automation system. In this example, an audio controller 104 is in communication with the master control unit 100 to receive command signals that may start and stop music playing from speakers 106 associated with the audio play portion of the system. Additionally, the master control unit 100 may be in communication with one or more light switch panels 108. As previously described, a light switch panel 108 may comprise multiple portions that each may be configured as a control button 110, where each control button 110 may be associated with a pre-configured or dynamically configured action group. Each control button 110 may then be configured to activate each device that is contained within the definition of the action group for the configured control button 110. The master control unit 100 is operable to selectively deliver a message to a particular control button 110 that is one portion of a light switch panel 108. Upon receipt of the control signal from the master control unit 100 the control button 110 on the light switch panel 108 may then send an activation signal and complete the electrical connection between the light switch panel 108 and a device, which may be a source of light such as a light bulb 112.

In this exemplary embodiment, the master control unit 100 may be in communication with a user through a mobile or handheld device such as, but not limited to, a mobile phone, iPad, tablet, network computer, laptop computer, or any other device configured with a display to permit the user to perform configuration tasks in communication with the master control unit 100. In a non-limiting example, the mobile or handheld device may be a tablet 120 that is in wireless communication with the master control unit 100. The tablet 120 has a display that permits the user to receive graphical menus and windows from which the user may enter data, make selections, initiate actions, and receive updates from the master control unit 100. The user may have complete control of the system configuration and operation from the tablet 120.

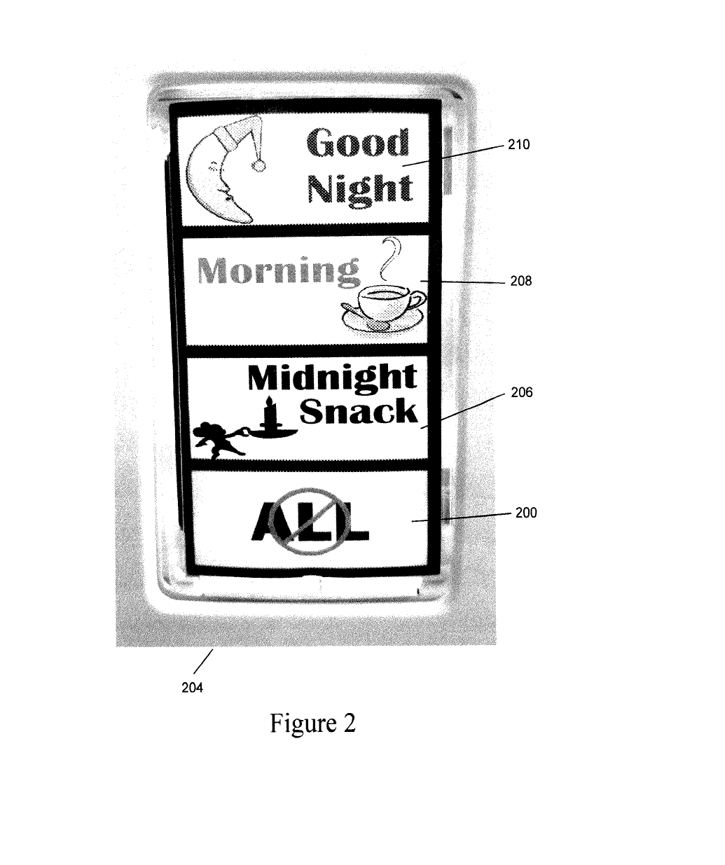

Turning now to FIG. 2, this figure presents a view of a multi-function control switch consistent with certain embodiments of the present invention. In an exemplary embodiment, the system presents a typical set of control buttons 200 that may be defined for use with a light switch panel 204. In a non-limiting example, the light switch panel 204 presented in the figure is configured with a possible four different configurable control buttons 200. In a non-limiting example, the light switch panel 204 may have different configurations, depending upon the needs and desires of a user. In this non-limiting example, the light switch panel 204 may be configured such that one control button 200 spans the entirety of the light switch panel 204. Alternatively, the light switch panel 204 may be configured such that the light switch panel 204 is divided into two portions, or into four portions, with each portion of the light switch panel 204 being configurable as a separate control button 200. In this non-limiting example, the light switch panel 204 is shown as being configured with four control button portions 200, one of which is labeled “midnight snack” 206, another is labeled “Morning” 208, another is labeled “Good night” 210. The fourth control button portion is a toggle to turn on and off all of the lights and devices that are associated with the circuit to which this light switch panel 204 is electrically connected.

As each control button portion is configured, each control button portion is associated with a set of devices and lights in the control button database updated, managed and maintained in the master control unit. Upon completion of the configuration, to activate the action group associated with the particular control button portion, the user may simply touch that portion of the light switch panel 204. Upon selection, the action group becomes active and sends a signal to the master control unit with an identification of the particular light switch panel 204 control button 200 that has been selected. The master control unit is operative to look up the identification of the control button 200, retrieve the list of devices associated with the particular control button 200, and transmit activation or deactivation signals to each device configured to be controlled from the selected control button 200.

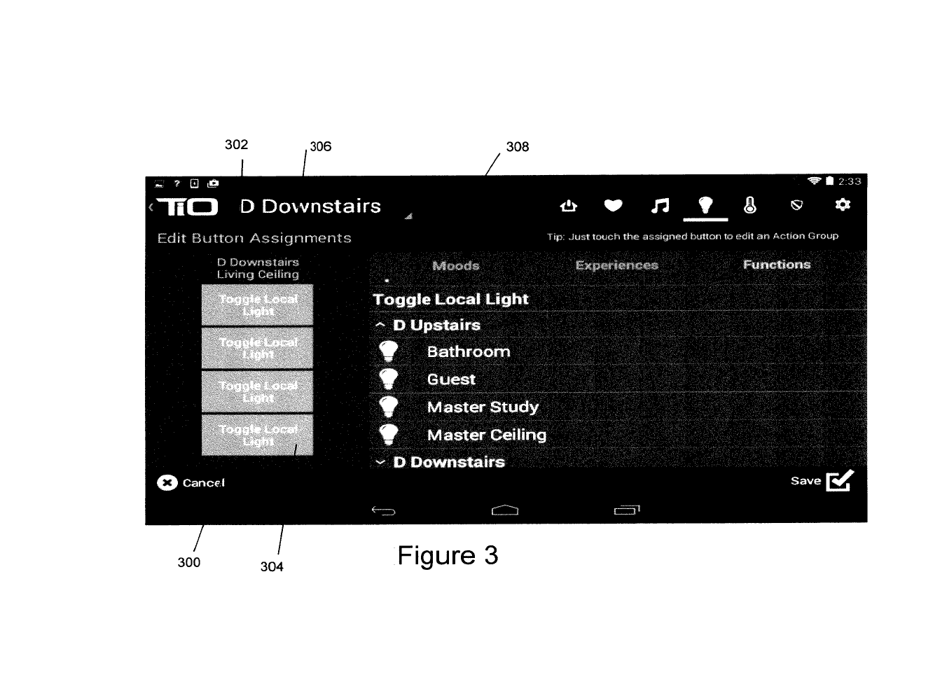

Turning now to FIG. 3, this figure presents an exemplary screen shot of a set of control areas that may be included in an action group consistent with certain embodiments of the present invention. In an exemplary embodiment, a location and configuration panel 300 permits a user to select the location of the light switch panel 302 and the control buttons 304 available on the particular light switch panel 302. In a non-limiting embodiment the configuration panel 300 may be associated with a database file containing all of the light switch panels 302 that may be accessed by a master control unit (not shown). A user may access the database file and select the light switch panel for which the user wishes to provide configuration information. The light switch panel information is retrieved and displayed in a graphical format, along with associated text, permitting the user to review the number of control buttons 304 that are associated with the selected light switch panel 302. Upon display of the control buttons 304, the user may be given the option to edit the device assignments 306 that may be controlled from any selected control button 304. The user may be presented with identifiers for devices 308 such as lights, sound sources, intercoms, security systems, thermostats, hot tub heater controls, or any other device that a user may wish to add to an action group definition. The device identifiers 308 may be attached to any electrical circuit or action group that may be addresses and controlled by the master control unit.

In an embodiment, the user may then proceed to configure an action group and assign the action group to a particular control button 304. The user may select a device identifier 308 by placing a cursor or finger on the device identifier 308. The user may then simply drag-and-drop, in the event of using a cursor, or swipe, in the event of using a finger on a touch sensitive screen, the device identifier 308 over to the particular control button 304 for which an action group is being defined. The device identifier 308, and by extension the device, is now associated with the particular control button 304 on the light switch panel 302 and is entered as a device within the action group. The master control unit builds a database file for the action group that now contains the information for the light switch panel 302, particular control button 304, and the one or more device identifiers 308 that the user has selected. The user may continue to select device identifiers 308 to associate with the control button 304 until the action group contains all of the device identifiers 308 the user wishes to control with the currently selected action group. The user may then select another control button 304 associated with the light switch panel 302 and define another action group as desired.

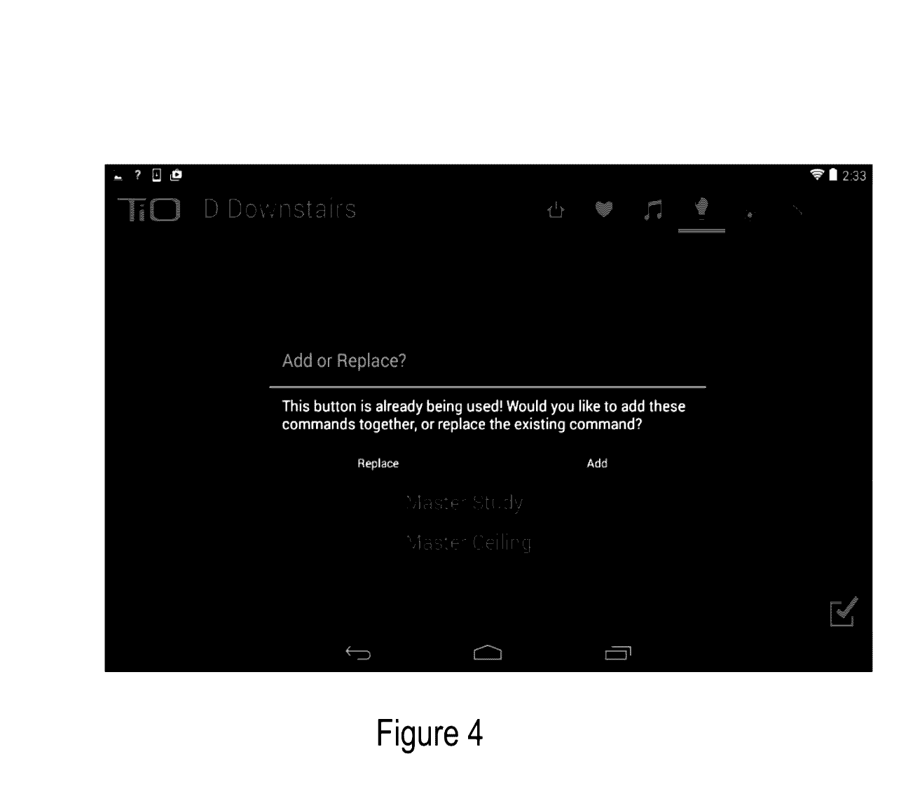

Turning now to FIG. 4, this figure presents an exemplary screen shot of an update to a control button consistent with certain embodiments of the present invention. In an exemplary embodiment, a user may also select a previously defined action group and add, delete, or update devices associated with the previously defined action group whenever the user desires to update or in any way change the configuration of an action group. Additionally, the user may select an action group and delete the action group entirely, freeing up a control button that may be reserved for future use.

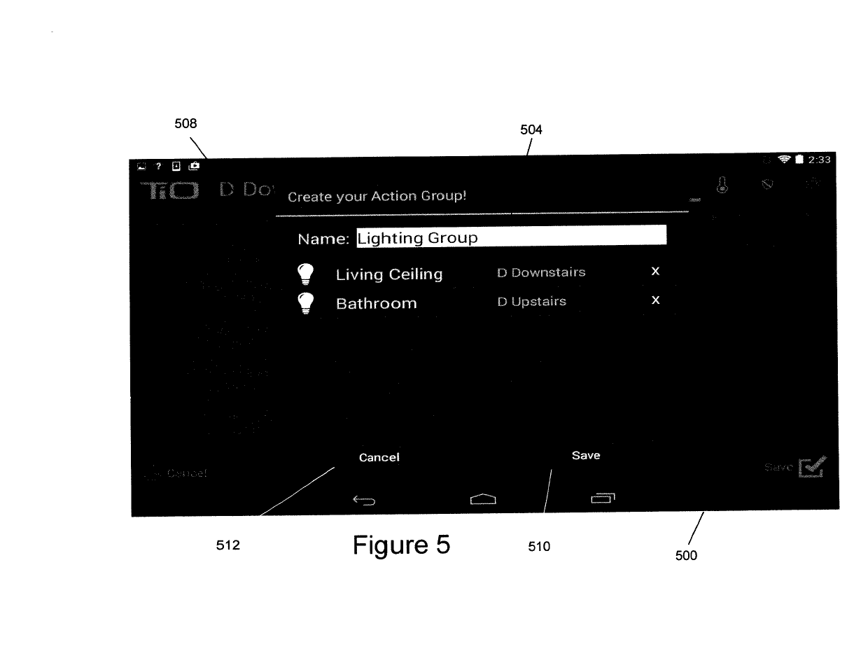

Turning now to FIG. 5, this figure presents an exemplary screen shot of the creation of an action group consistent with certain embodiments of the present invention. In this embodiment, upon an indication from the user that all configuration edits are complete, the master control unit will prepare an action group information data block within the action group database file. The master control unit may then present the user with a display 500 containing the configuration information that will be saved with the action group information data block. The display 500 may contain a name for the action group 504, in the instance of updating an action group, or may permit the user to input a name 504 for the newly defined action group. Upon the input of the name 504 for the action group, the master control unit may save this information in the title area of the action group information data block. The user will also be presented with the device identifier for each device 508 that the user has selected as being a part of the defined action group.

In this exemplary embodiment, the user may then save the displayed configuration information for the action group 504 by selecting the “SAVE” icon 510, whereupon the master control unit will commit the data changes to the database file. Alternatively, the user may decide to cancel the current action group configuration by selecting the “CANCEL” icon 512. Canceling the current action group configuration may return the user to the configuration display, where the user may define an action group again, or exit the action group configuration function entirely.

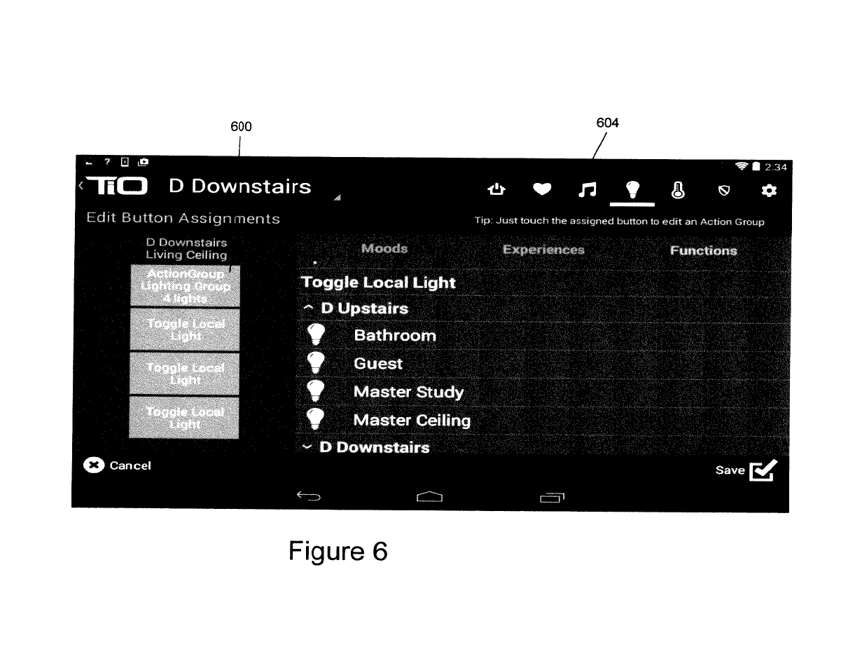

Turning now to FIG. 6, this figure presents an exemplary screen shot of an action group associated with a control button consistent with certain embodiments of the present invention. In this embodiment, an action group has been defined for the control button in the top most portion of the lighting switch panel 600. In this embodiment, the lighting panel switch may have an additional three control buttons to which action groups may be assigned. The user is presented with this view of the edit button assignments display to permit the user to select another control button for assignment, or to permit the user to review the action groups currently assigned to the control buttons associated with this lighting switch panel. The user may review the control button assignments, update control button assignments, define control button assignments, or delete any currently defined action groups associated with the one or more control buttons on the selected lighting switch panel.

In the exemplary embodiment, the system is also active to provide tips for actions by the user that may be performed with control button assignments. In a non-limiting example, the user may be presented with a tip 604 on the screen providing an action available to the user on the display. Any number of tips may be provided to the user. Tips 604 may be pre-configured and saved in a database file from which tips 604 may be selected for display based upon the user's interaction with the system, or based upon a random selection by the system of those tips 604 that are relevant to the display the user is currently viewing.

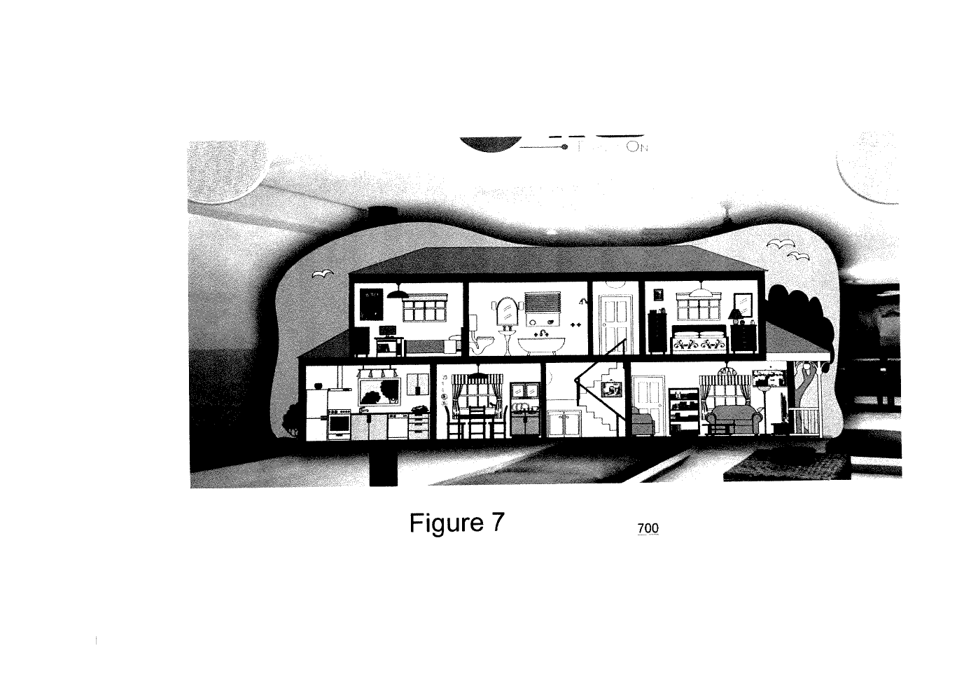

Turning now to FIG. 7, this figure presents a view of an initial state for the system configuration on a display device consistent with certain embodiments of the present invention. In this embodiment, the system may present a user with an exemplary diagram of a property, such as a home, rental home, personal office, apartment, condo, or other property for which the user desires automation of home functions 700. In this view, all of the devices, such as lights, thermostats, audio systems, security systems, appliances, or any other device for which the user might wish to control individually or as part of an action group, are presented to the user in a single display. In a non-limiting example, all controllable devices and systems are currently in an off condition. The user may review this display as a baseline display to review all action group assignments by starting from a known off position.

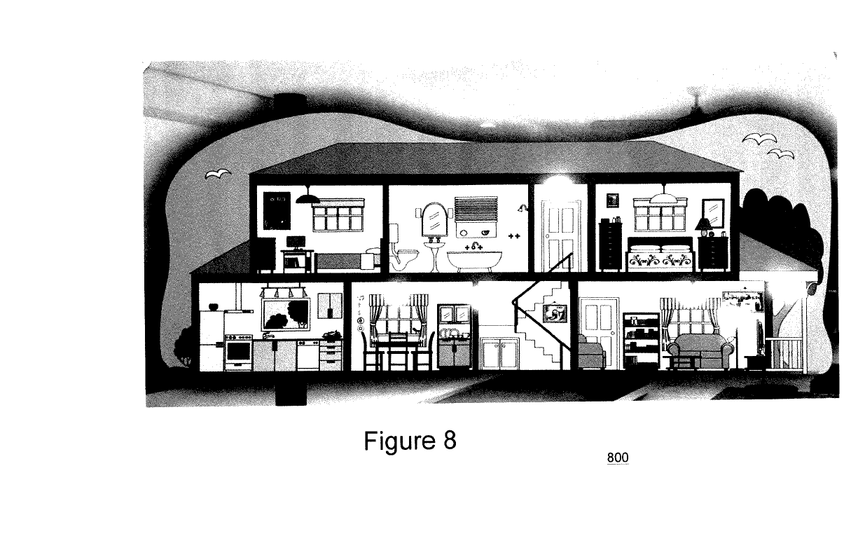

Turning now to FIG. 8, this figure presents a view of an action group activated consistent with certain embodiments of the present invention. In this embodiment, the user may activate one or more action groups by selecting the control buttons to which the user group(s) are assigned to review the operation of one or more action groups when activated. In a non-limiting example, an action group may have a particular set of lights and other devices that may activate on the display to provide the user with visual confirmation of the devices being controlled by the one or more selected action groups. From this display, the user may determine whether the action group does activate the expected lights and other devices that the user has previously defined for the selected action group(s).

While certain illustrative embodiments have been described, it is evident that many alternatives, modifications, permutations and variations will become apparent to those skilled in the art in light of the foregoing description.

What is claimed is:

1. A system, comprising:
a processor;
a management software module installed on the processor operative to control one or more electrical devices;
an input device in communication with the processor available to a user to input electrical device identification information;
a database accessible by the processor operative to receive the input electrical device identification information;
a software module operative to define one or more action groups where each action group comprises multiple electrical device identification information; and
the management software module simultaneously controlling the state of each electrical device in each defined action group at the request of a user.

2. The system of claim 1, further comprising icons on a user accessible display representing the one or more electrical devices available to select for inclusion in an action group.

3. The system of claim 2, where an electrical device icon is selected by a user through a drag and drop interface.

4. The system of claim 1, where controlling the state of an electrical device comprises toggling the electrical device from an on state to an off state, or from an off state to an on state.

5. The system of claim 4, where controlling the state of an electrical device further comprises adjusting any variable capability of an electrical device after the electrical device has been toggled from an off state to an on state.

6. A method, comprising:
controlling the state of one or more electrical devices through the operation of a management software module installed on a processor;
receiving input from a user through the operation of an input device in communication with the processor where the input from a user comprises electrical device identification information;
storing the input electrical device identification information into a database accessible by the processor;
defining one or more action groups where each action group comprises multiple electrical device identification information; and
simultaneously controlling the state of each electrical device in each defined action group at the request of a user.

7. The system of claim 6, further comprising displaying icons on a user accessible display representing the one or more electrical devices available to select for inclusion in an action group.

8. The system of claim 7, where an electrical device icon is selected by a user through a drag and drop interface.

9. The system of claim 6, where controlling the state of an electrical device comprises toggling the electrical device from an on state to an off state, or from an off state to an on state.

10. The system of claim 9, where controlling the state of an electrical device further comprises adjusting any variable capability of an electrical device after the electrical device has been toggled from an off state to an on state.
